(19) United States
(12) Patent Application Publication
(10) Pub. No.: US 2026/0051950 A1
(43) Pub. Date: Feb. 19, 2026

(54) METHOD FOR INTER-SATELLITE BEAM-HOPPING SCHEDULING, ELECTRONIC DEVICE AND STORAGE MEDIUM

(71) Applicant: BEIJING UNIVERSITY OF POSTS AND TELECOMUNICATIONS, Beijing (CN)

(72) Inventors: Xing Zhang, Beijing (CN); Hao Chen, Beijing (CN); Wenbo Wang, Beijing (CN); Jiaxin Zhang, Beijing (CN)

(21) Appl. No.: 19/020,786

(22) Filed: Jan. 14, 2025

(30) Foreign Application Priority Data
Aug. 14, 2024 (CN) 202411114085.6

(51) Int. Cl. H04B 7/185

(52) U.S. Cl. CPC H04B 7/18521

(57) ABSTRACT

The present disclosure provides a method for inter-satellite beam-hopping scheduling, electronic device and storage medium. The method is applied to a first satellite, wherein service ranges of the first satellite and a second satellite have an overlapping area, and the method includes: comparing, in response to edge users existing in the overlapping area, a first edge user density of the first satellite and a second edge user density of the second satellite, before a next scheduling cycle starts; traversing, in response to the first edge user density being lower than the second edge user density, time slots in the next scheduling cycle, to determine whether to adjust a first beam-hopping pattern pre-determined for the first satellite; adjusting, in response to determining to adjust the first beam-hopping pattern, the first beam-hopping pattern to obtain a second beam-hopping pattern; and performing, in the next scheduling cycle, beam-hopping service for a traffic beam according to the second beam-hopping pattern.

### CROSS REFERENCE

This disclosure claims priority to Chinese Patent Application No. 202411114085.6, entitled “Inter-satellite beam-hopping scheduling coordination method, device, electronic device and storage medium” filed on Aug. 14, 2024, which is incorporated by reference in its entirety.

### TECHNICAL FIELD

The present disclosure relates to the field of satellite communication systems, and in particular to a method for inter-satellite beam-hopping scheduling, electronic device and storage medium.

### BACKGROUND

In recent years, with rapid development of space technologies and satellite communication technologies, large-scale low-orbit satellite constellation systems have gradually become a research hotspot in industry and academia.

Large-scale constellations bring denser beams and more frequent and severe interference. Low-orbit satellites mean highly dynamic cell changes, rapid changes in satellite service ranges, and frequent switching of satellite-to-ground links. In this context, inter-satellite beam-hopping scheduling, coordination and resource collaborative allocation have become important technologies to ensure the efficiency and quality of large-scale low-orbit satellite constellation communications.

However, in the related art, when an edge user is available in an overlapping area of service ranges of any two satellites, inter-satellite interference arises, which affects the overall throughput performance of the constellation system.

### SUMMARY

According to one or more embodiments, a method for inter-satellite beam-hopping scheduling is provided. The method is applied to a first satellite, wherein service ranges of the first satellite and a second satellite have an overlapping area, and the method includes:
comparing, in response to edge users existing in the overlapping area, a first edge user density of the first satellite and a second edge user density of the second satellite, before a next scheduling cycle starts, edge users being users in an edge signaling beamfoot, the edge signaling beamfoot being a signaling beamfoot in the overlapping area, and an edge user density being the number of users per unit area on the edge signaling beamfoot;
traversing, in response to the first edge user density being lower than the second edge user density, time slots in the next scheduling cycle, to determine whether to adjust a first beam-hopping pattern pre-determined for the first satellite;
adjusting, in response to determining to adjust the first beam-hopping pattern, the first beam-hopping pattern to obtain a second beam-hopping pattern; and
performing, in the next scheduling cycle, beam-hopping service for a traffic beam according to the second beam-hopping pattern.

According to one or more embodiments, an electronic device is provided. The electronic device, comprising a memory, a processor, and a computer program stored in the memory that, when executed by the processor, causes the processor to:
compare, in response to edge users existing in an overlapping area, a first edge user density of the first satellite and a second edge user density of the second satellite, before a next scheduling cycle starts, service ranges of the first satellite and a second satellite having the overlapping area, edge users being users in an edge signaling beamfoot, the edge signaling beamfoot being a signaling beamfoot in the overlapping area, and an edge user density being the number of users per unit area on the edge signaling beamfoot;
traverse, in response to the first edge user density being lower than the second edge user density, time slots in the next scheduling cycle, to determine whether to adjust a first beam-hopping pattern pre-determined for the first satellite;
adjust, in response to determining to adjust the first beam-hopping pattern, the first beam-hopping pattern to obtain a second beam-hopping pattern; and
perform, in the next scheduling cycle, beam-hopping service for a traffic beam according to the second beam-hopping pattern.

According to one or more embodiments, a non-transitory computer readable medium is provided. The non-transitory computer readable medium storing a computer program causing a computer to execute a process, the process comprising:
comparing, in response to edge users existing in an overlapping area, a first edge user density of the first satellite and a second edge user density of the second satellite, before a next scheduling cycle starts, service ranges of the first satellite and a second satellite having the overlapping area, edge users being users in an edge signaling beamfoot, the edge signaling beamfoot being a signaling beamfoot in the overlapping area, and an edge user density being the number of users per unit area on the edge signaling beamfoot;
traversing, in response to the first edge user density being lower than the second edge user density, time slots in the next scheduling cycle, to determine whether to adjust a first beam-hopping pattern pre-determined for the first satellite;
adjusting, in response to determining to adjust the first beam-hopping pattern, the first beam-hopping pattern to obtain a second beam-hopping pattern; and
performing, in the next scheduling cycle, beam-hopping service for a traffic beam according to the second beam-hopping pattern.

### BRIEF DESCRIPTION OF THE DRAWINGS

FIG. 1 is a schematic diagram of an edge user access process according to an embodiment of the present disclosure;

FIG. 2 is a schematic diagram of another edge user access process according to an embodiment of the present disclosure;

FIG. 3 is a schematic diagram of a flow chart of a method for inter-satellite beam-hopping scheduling according to an embodiment of the present disclosure;

FIG. 4 is a schematic diagram of another method for inter-satellite beam-hopping scheduling according to an embodiment of the present disclosure;

FIG. 5 is a schematic diagram of a satellite constellation system according to an embodiment of the present disclosure;

FIG. 6 is a schematic diagram of beam scheduling architecture according to an embodiment of the present disclosure;

FIG. 7 is a schematic diagram of adjusting a beam-hopping pattern according to an embodiment of the present disclosure;

FIG. 8 is a graph showing performance results according to an embodiment of the present disclosure;

FIG. 9 is a schematic diagram of the structure of an apparatus for inter-satellite beam-hopping scheduling according to an embodiment of the present disclosure;

FIG. 10 is a schematic diagram of the physical structure of an electronic device provided according to an embodiment of the present invention.

### DESCRIPTION OF EMBODIMENTS

The following will be combined with the drawings in the embodiments of the present disclosure to clearly and completely describe the technical solutions in the embodiments of the present disclosure. Obviously, the described embodiments are only part of the embodiments of the present disclosure, not all of the embodiments. Based on the embodiments in the present disclosure, all other embodiments obtained by ordinary technicians in this field without creative work are within the scope of protection of this disclosure.

The terms “first”, “second”, “third”, “fourth”, etc. (if any) in the specification and claims of the present invention and the above-mentioned drawings are used to distinguish similar objects, and are not necessarily used to describe the order or precedence of the objects. It should be understood that the data used in this way can be interchanged where appropriate, so that the implementation of the present invention described herein can be implemented in an order other than those illustrated or described herein, for example. In addition, the terms “including” and “having” and any variations thereof are intended to cover non-exclusive inclusions. For example, a process, method, system, product or device that includes a series of steps or units is not necessarily limited to those steps or units that are clearly listed, but may include other steps or units that are not clearly listed or inherent to these processes, methods, products or devices.

The technical solution of the present invention is described in detail with specific embodiments below. The following specific embodiments can be combined with each other, and the same or similar concepts or processes may not be described in detail in some embodiments.

In embodiments of the present disclosure, a method for inter-satellite beam-hopping scheduling is disclosed. Before the start of the next scheduling cycle, in response to edge users existing in the overlapping area of the service range of the first satellite and the second satellite, and the satellite with a smaller density of edge users determines that the beam-hopping pattern is required to be adjusted on the satellite side, the method adjusts the beam-hopping pattern; and in the next scheduling cycle, the beam-hopping service for the traffic beam is performed according to the adjusted beam-hopping pattern.

This solution can avoid inter-satellite interference for edge users, and can thereby improve the overall throughput performance of the constellation system and the service experience of edge users. Allocation of beam-hopping space-time resources in satellite communication networks is optimized, and can thereby maximize the performance of satellite communication networks under limited resource conditions, including increasing communication rates, reducing delays, increasing system capacity and improving signal quality.

The method for inter-satellite beam-hopping scheduling provided in the embodiments of the present disclosure is applied in a large-scale low-orbit satellite constellation system. In the constellation system, there is a situation where the service ranges of two satellites overlap. For the convenience of description below, a satellite in the constellation system is selected as a first satellite; a satellite whose service range overlaps with the first satellite is called a second satellite.

The first satellite polls, through a signaling beam, each user in a coverage area of the first satellite according to a pre-determined signaling beamfoot, and obtains information reported by a user terminal of the each user, to determine whether the each user is accessed to the first satellite.

The second satellite polls, through a signaling beam, each user in a coverage area of the second satellite according to a pre-determined signaling beamfoot, and obtains information reported by a user terminal of the each user, to determine whether the each user is accessed to the second satellite.

In embodiments of the present disclosure, the users under a coverage area of the satellite are also called as under-satellite users.

The information reported by the user through the user terminal includes service requests, location information, etc.

The signaling beam and the traffic beam for each satellite work together, specifically:
The signaling beam is responsible for accessing new users through polling and receiving service requests from the user terminals;
The traffic beam provides beam-hopping services for accessed users.

In the constellation systems, multiple satellites equipped with phased array multi-beam antennas synchronously carry out traffic beam scheduling cycles. Before the start of a traffic beam scheduling cycle, two satellites with overlapping service ranges share their observation data, status information and beam usage through inter-satellite links.

The traffic beam and signaling beam may adopt an independent beamfoot configuration, i.e., the traffic beamfoots allocated to the traffic beam may be different from the signaling beamfoots allocated to the signaling beam. And for different satellites, the way to allocate the traffic beamfoots and the signaling beamfoots may be the same.

The edge user is a user at an edge signaling beamfoot, and the edge signaling beamfoot is a signaling beamfoot at an overlapping area between the service range of the first satellite and the service range of the second satellite.

When an edge user wants to access a satellite, the user terminal of the edge user first monitors the satellite's synchronization signal and Physical Broadcast Channel (PBCH) block (SSB). Once a SSB of a satellite is monitored, the user terminal sends an access request (MsgA) to the satellite.

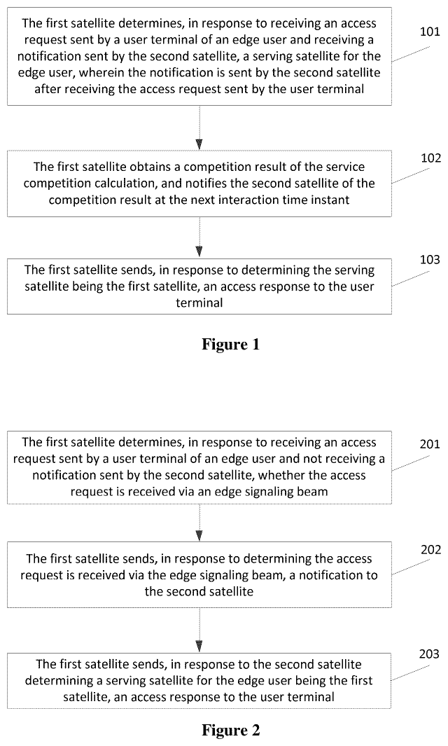

FIG. 1 is a schematic diagram of an edge user access process in an embodiment of the present disclosure, including the following steps:

Step 101: The first satellite determines, in response to receiving an access request sent by a user terminal of an edge user and receiving a notification sent by the second satellite, a serving satellite for the edge user, wherein the notification is sent by the second satellite after receiving the access request sent by the user terminal.

In response to receiving the access request sent by a user terminal of an edge user and receiving the notification sent by the second satellite, the first satellite performs service contention calculation, i.e., to determine which satellite is the serving satellite for the edge user.

In an embodiment, the first satellite first receives the notification sent by the second satellite and then receives the access request sent by an edge user. In such case, the first satellite performs service contention calculation.

When the second satellite sends a notification to the first satellite, the notification is used to notify two items:
1) A first item, indicating that an access request sent by an edge user has been received by the second satellite;
2) A second item, including information used for service competition calculation, including user density, signal strength, satellite load, etc.

The specific process of service competition calculation is not limited in the embodiments of the present disclosure.

Step 102: The first satellite obtains a competition result of the service competition calculation, and notifies the second satellite of the competition result at the next interaction time instant.

Step 103: The first satellite sends, in response to determining the serving satellite being the first satellite, an access response to the user terminal.

If the first satellite is determined as the service satellite for the edge user according to the competition result, an access response is sent to the user terminal of the edge user.

After receiving the access response sent by the first satellite, the user terminal accesses the first satellite.

If the second satellite is determined as the service satellite for the edge user according to the competition result, the first satellite will not access the edge user.

Through this embodiment, by comprehensively considering which satellite the edge users should access based on the user density, signal strength, and satellite load, the throughput of the satellite constellation system is improved.

FIG. 2 is a schematic diagram of another edge user access process in an embodiment of the present disclosure, including the following steps:

Step 201: The first satellite determines, in response to receiving an access request sent by a user terminal of an edge user and not receiving a notification sent by the second satellite, whether the access request is received via an edge signaling beam.

In this embodiment, the first satellite, prior to the second satellite, receives the access request sent by the new edge user. In such case, it is necessary to identify the access request, i.e., determine whether the access request is received via an edge signaling beam.

Step 202: The first satellite sends, in response to determining the access request is received via the edge signaling beam, a notification to the second satellite.

In this step, a notification is sent to a second satellite that shares the edge signaling beam at a next interaction time instant.

This notification is used to notify two items:
1) A first item, indicating that an access request sent by an edge user has been received by the second satellite;
2) A second item, including information used for service competition calculation, including user density, signal strength, satellite load, etc.

In this application scenario, the second satellite performs service contention calculation and notifies the first satellite of the contention result.

Step 203: The first satellite sends, in response to the second satellite determining a serving satellite for the edge user being the first satellite, an access response to the user terminal.

In this step, the first satellite receives the competition result from the second satellite. The competition result may indicate that the first satellite is determined to be the service satellite for the edge user. Then, an access response is sent to the user terminal of the edge user, and the second satellite will not access the edge user.

Through this embodiment, by comprehensively considering which satellite the edge users should access based on the user density, signal strength, and satellite load, the throughput of the satellite constellation system is improved.

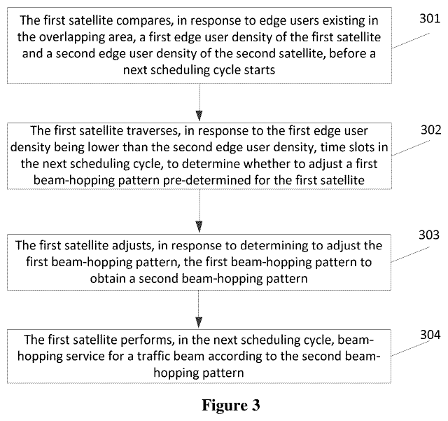

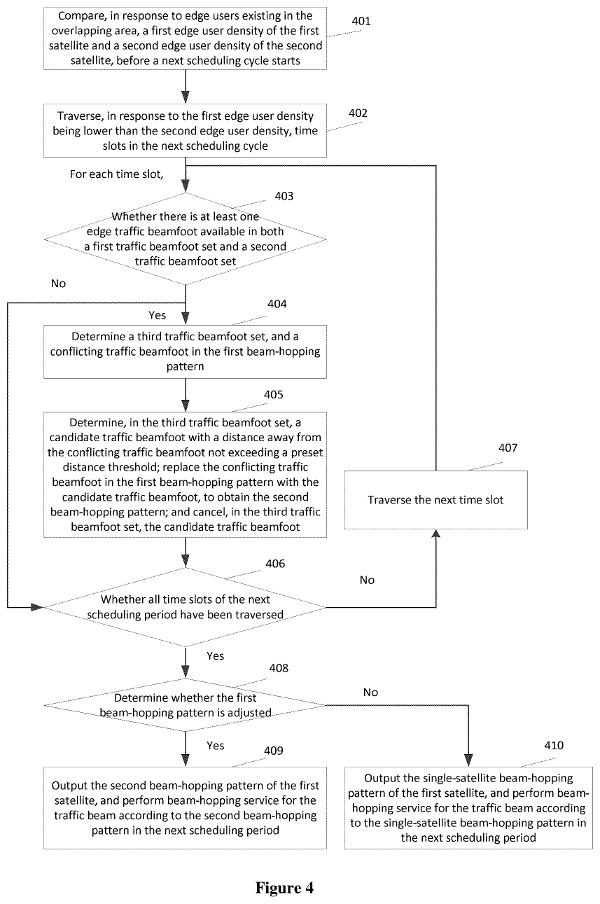

Before the start of each next scheduling cycle, it is necessary to determine whether there are edge users in the overlapping area between the first satellite and the second satellite. If so, it is necessary to determine whether the pre-determined beam-hopping pattern is required to adjust. The detailed process is given below through FIGS. 3 and 4. If it is determined that there are no edge users in the overlapping area, it is directly determined that there is no need to adjust the beam-hopping pattern. In the next scheduling cycle, the pre-determined beam-hopping pattern of the first satellite can be directly used.

FIG. 3 is a schematic diagram of a flow chart of a method for inter-satellite beam-hopping scheduling in an embodiment of the present disclosure, including the following steps:

Step 301: The first satellite compares, in response to edge users existing in the overlapping area, a first edge user density of the first satellite and a second edge user density of the second satellite, before a next scheduling cycle starts.

Edge users are users in an edge signaling beamfoot. The edge signaling beamfoot is a signaling beamfoot in the overlapping area, and an edge user density is the number of users per unit area on the edge signaling beamfoot.

In embodiments of the present disclosure, a coverage area of a satellite include multiple beamfoots in the ground surface of the earth. Hence, a beamfoot means an area that a beam radiates in the ground surface. For a signaling beam, a signaling beamfoot is obtained; for a traffic beam, a traffic beamfoot is obtained.

In each scheduling period, the first satellite and the second satellite interact with each other about the edge user density. Therefore, in each scheduling period, the first satellite can obtain the second edge user density of the second satellite.

Step 302: The first satellite traverses, in response to the first edge user density being lower than the second edge user density, time slots in the next scheduling cycle, to determine whether to adjust a first beam-hopping pattern pre-determined for the first satellite.

In an embodiment, the first satellite performs, in response to the second edge user density being lower than the first edge user density, the beam-hopping service for the traffic beam according to the first beam-hopping pattern in the next scheduling cycle.

The first beam-hopping pattern refers to a single-satellite beam-hopping pattern of the first satellite, which may be pre-determined.

In this scenario, the first satellite does not adjust the first beam-hopping pattern, and in the next scheduling period, the single-satellite beam-hopping pattern of the first satellite is used to provide beam-hopping service for the traffic beam.

In an embodiment, the first satellite performs, in response to determining not to adjust the first beam-hopping pattern, the beam-hopping service for the traffic beam according to the first beam-hopping pattern in the next scheduling cycle.

In this scenario, the first beam-hopping pattern, i.e., the single-satellite beam-hopping pattern of the first satellite, is directly used to provide the beam-hopping service for the traffic beam.

In embodiments of the present disclosure, a beam-hopping pattern is composed by a plurality of grids, and each grid represents a traffic beamfoot in a time slot.

Step 303: The first satellite adjusts, in response to determining to adjust the first beam-hopping pattern, the first beam-hopping pattern to obtain a second beam-hopping pattern.

Step 304: The first satellite performs, in the next scheduling cycle, beam-hopping service for a traffic beam according to the second beam-hopping pattern.

In an embodiment, in step 302, the traversing includes:
for each time slot, performing the following:
determining whether there is at least one edge traffic beamfoot available in both a first traffic beamfoot set and a second traffic beamfoot set, wherein
   the edge traffic beamfoot is a traffic beamfoot in the overlapping area,
   the first traffic beamfoot set is a set of traffic beamfoots being illuminated in the first beam-hopping pattern, and
   the second traffic beamfoot set is a set of traffic beamfoots being illuminated in a pre-determined beam-hopping pattern of the second satellite;
determining, in response to the at least one edge traffic beamfoot being available in both the first traffic beamfoot set and the second traffic beamfoot set, that the first beam-hopping pattern is to be adjusted.

In embodiments of the present disclosure, a traffic beamfoot being illuminated means the area of the traffic beamfoot in the ground surface is radiated by a traffic beam.

In step 303, the first satellite further determines a third traffic beamfoot set, and the third traffic beamfoot set includes at least one candidate traffic beamfoot. The adjusting including:
for each time slot, performing the following:
   determining a conflicting traffic beamfoot in the first beam-hopping pattern within the respective time slot, the conflicting traffic beamfoot being one of the at least one edge traffic beamfoot;
   determining, in the third traffic beamfoot set, a candidate traffic beamfoot with a distance away from the conflicting traffic beamfoot not exceeding a preset distance threshold; and
   replacing the conflicting traffic beamfoot in the first beam-hopping pattern with the candidate traffic beamfoot, to obtain the second beam-hopping pattern.

In embodiments of the present disclosure, the conflicting traffic beamfoot may refer to an edge traffic beamfoot in the overlapping area of two satellites.

In some embodiments of the present disclosure, the conflicting traffic beamfoot may refer to a same edge traffic beamfoot illuminated by two edge beams of two different satellites simultaneously in a same time slot.

In practical application, the beamfoot configuration may be dynamic with the movement of the satellite and the variant coverage. The location of a beamfoot in the ground surface may also be variant. In some embodiments of the present disclosure, the conflicting traffic beamfoot may refer to an edge traffic beamfoot conflicted by another edge traffic beamfoot. These two edge traffic beamfoots are illuminated by two edge beams of two adjacent satellites respectively in a same time slot. Centers of the two edge beams in the ground surface are close to each other. In some examples, the distance between two centers in the ground surface is lower than a preset center distance. Under a same beam frequency, when the distance between two centers is smaller than the preset center distance, an amount of interference may be caused due to the sidelobe leakage of the beam; otherwise, when the distance between two centers is larger than the preset center distance, the interference may be negligible.

In an embodiment, the conflicting traffic beamfoot in the first beam-hopping pattern may be represented by a grid, and all the conflicting traffic beamfoots may make up a set of grids.

The distance between the candidate traffic beamfoot and the conflicting traffic beamfoot may refer to the distance between two centers of the candidate traffic beamfoot and the conflicting traffic beamfoot in the ground surface, i.e., the ground distance between centers.

When there are a plurality of candidate traffic beamfoots with distances away from the conflicting traffic beamfoot not exceeding a preset distance threshold, the determined candidate traffic beamfoot for the following replacement may be the candidate traffic beamfoot which is closet to the conflicting traffic beamfoot among the above plurality of candidate traffic beamfoots with distances not exceeding the preset distance threshold.

In an embodiment, after the replacing, the following operations are further performed:
cancelling, in the third traffic beamfoot set, the candidate traffic beamfoot that replaces the conflicting traffic beamfoot in the first beam-hopping pattern;
The determining the third traffic beamfoot set includes:
determining the third traffic beamfoot set based on the first traffic beamfoot set, a fourth traffic beamfoot set, and a fifth traffic beamfoot set, wherein
   the fourth traffic beamfoot set is a set of traffic beamfoots of the first satellite corresponding to the edge users;
   the fifth traffic beamfoot set corresponds to a time slot within which no edge traffic beamfoots of the first satellite are illuminated and at least one edge traffic beamfoot of the second satellite is illuminated.

In this embodiment, the time slot corresponding to the fifth traffic beamfoot set is not allowed for traffic beam replacement. And this time slot may be determined through set operations and logical operations among the first traffic beamfoot set, the second traffic beamfoot set, the fourth traffic beamfoot set and the sixth traffic beamfoot set.

The sixth traffic beamfoot set is a set of traffic beamfoots of the second satellite corresponding to the edge users.

The determining the third traffic beamfoot set includes:
cancelling, in the first traffic beamfoot set, traffic beamfoots available in both the fourth traffic beamfoot set and the fifth traffic beamfoot set;
determining the first traffic beamfoot set after the cancelling as the third traffic beamfoot set.

FIG. 4 is a flow chart of another method for inter-satellite beam-hopping scheduling in an embodiment of the present disclosure, including the following steps:

Step 401: The first satellite compares, in response to edge users existing in the overlapping area, a first edge user density of the first satellite and a second edge user density of the second satellite, before a next scheduling cycle starts.

Step 402: The first satellite traverses, in response to the first edge user density being lower than the second edge user density, time slots in the next scheduling cycle.

When the second edge user density of the second satellite is lower than the first edge user density, the first satellite does not perform determining whether to adjust the first beam-hopping pattern, and subsequently in the next scheduling period, directly performs beam-hopping service for the traffic beam based on the single-satellite beam-hopping pattern of the first satellite.

Step 403: For each time slot, the first satellite determines whether there is at least one edge traffic beamfoot available in both a first traffic beamfoot set and a second traffic beamfoot set; if yes, execute step 404; otherwise, execute step 406.

The first traffic beamfoot set is a set of traffic beamfoots being illuminated in the first beam-hopping pattern, and the second traffic beamfoot set is a set of traffic beamfoots being illuminated in a pre-determined beam-hopping pattern of the second satellite.

Step 404: The first satellite determines a third traffic beamfoot set, and a conflicting traffic beamfoot in the first beam-hopping pattern within the respective time slot.

The third traffic beamfoot set includes at least one candidate traffic beamfoot. The conflicting traffic beamfoot may be one of the at least one edge traffic beamfoot in the above Step 403.

If a third traffic beamfoot set exists, obtaining the third traffic beamfoot set directly;

If the third traffic beamfoot set does not exist, the third traffic beamfoot set is determined based on the first traffic beamfoot set, a fourth traffic beamfoot set, and a fifth traffic beamfoot set, wherein the fourth traffic beamfoot set is a set of traffic beamfoots of the first satellite corresponding to the edge users; and the fifth traffic beamfoot set corresponds to a time slot within which no edge traffic beamfoots of the first satellite are illuminated and at least one edge traffic beamfoot of the second satellite is illuminated.

If the third traffic beamfoot set exists, it means that the third traffic beamfoot set has been stored, and can be directly obtained; if the third traffic beamfoot set does not exist, it means that the third traffic beamfoot set has not been determined in this scheduling period, so the third traffic beamfoot set is determined.

Step 405: The first satellite determines, in the third traffic beamfoot set, a candidate traffic beamfoot with a distance away from the conflicting traffic beamfoot not exceeding a preset distance threshold; replaces the conflicting traffic beamfoot in the first beam-hopping pattern with the candidate traffic beamfoot, to obtain the second beam-hopping pattern; and cancels, in the third traffic beamfoot set, the candidate traffic beamfoot.

The preset distance threshold can be set according to actual needs, and the embodiment of the present disclosure is not limited to this.

Step 406: The first satellite determines whether all time slots of the next scheduling period have been traversed, if so, execute step 408; otherwise, execute step 407.

Step 407: The first satellite traverses the next time slot and execute step 403.

Step 408: The first satellite determines whether the first beam-hopping pattern is adjusted, if so, executing step 409; otherwise, executing step 410;

Step 409: The first satellite outputs the second beam-hopping pattern of the first satellite, and performs beam-hopping service for the traffic beam according to the second beam-hopping pattern in the next scheduling period. This process ends.

Step 410: The first satellite outputs the single-satellite beam-hopping pattern of the first satellite, and performs beam-hopping service for the traffic beam according to the single-satellite beam-hopping pattern in the next scheduling period.

On the one hand, methods as described in embodiments of the present disclosure can balance the inter-satellite load to adapt to the differentiated distribution scenarios of global users and business traffic, well improve the performance of the satellite communication system and optimize the utilization of network resources. On the other hand, it can suppress inter-satellite interference while minimizing the difference in beam-hopping patterns before and after the adjustment, so that the throughput of edge users is improved, and the service experience of edge users is improved.

The interaction time instant in the embodiment of the present disclosure refers to the time instant when a notification is sent after receiving an access request sent by an edge user or when a competition result is sent after a service competition calculation.

The method for inter-satellite beam-hopping scheduling in the embodiment of the present disclosure is described in detail below with reference to specific examples.

After the user accesses the satellite, the satellite provides periodic beam-hopping services. In the fixed beam-hopping period, the satellite periodically collects user information within the coverage area, and runs the beam scheduling algorithm on the satellite to calculate the beam-hopping pattern for the next beam scheduling period. The beam scheduling algorithm is based on a completely hotspot-driven beam-hopping mechanism. The input of the algorithm is determined by the distribution of users and their own service requests. The optimization result is executed by the satellite via beam-hopping.

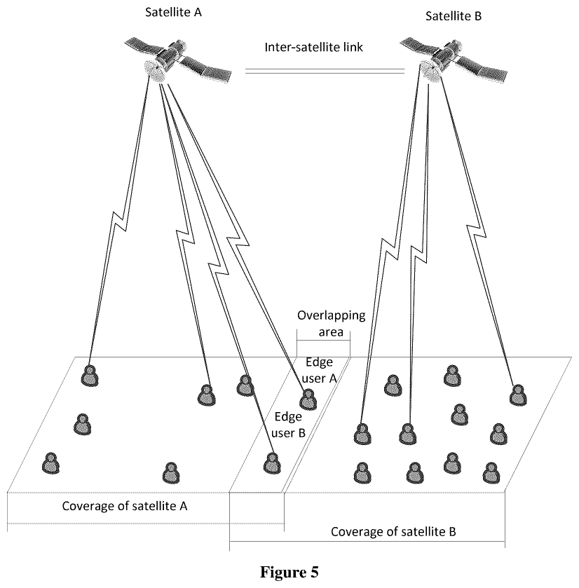

FIG. 5 is a schematic diagram of a satellite constellation system in an embodiment of the present disclosure. In FIG. 5, there is an overlapping area between the coverage area (or service range) of satellite A and the coverage area of satellite B. Edge users A and B are users in edge signaling beamfoots, and edge signaling beamfoots are signaling beamfoots in the overlapping area. Edge users can receive signaling beams from both satellites A and B at the same time.

Each satellite performs its own beam-hopping scheduling process independently, to pre-determine its own single-satellite beam-hopping pattern. The pre-determined single-satellite beam-hopping pattern may be used as the first beam-hopping pattern.

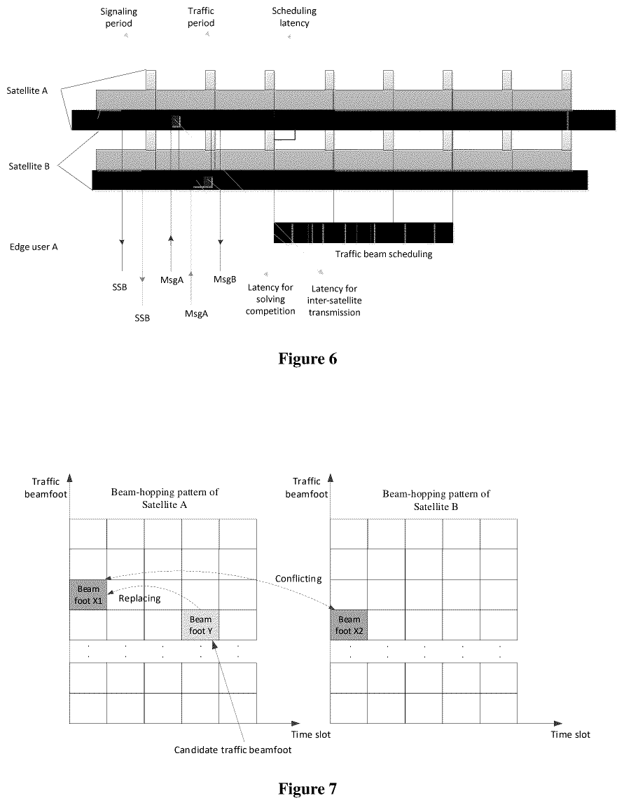

FIG. 6 is a schematic diagram of beam scheduling architecture in an embodiment of the present disclosure. When an edge user A needs to access a satellite, the user terminal A of an edge user A first monitors a Synchronization Signal and Physical Broadcast Channel (PBCH) block (SSB) from a satellite A, then the user terminal A sends an access request (MsgA) to the satellite A. after this, the user terminal A monitors an SSB of a satellite B, and then sends a MsgA to the satellite B.

The edge user usually monitors SSBs of two satellites, so it needs to send access requests to both satellites and then access one satellite from which an access response (MsgB) is received.

After receiving the MsgA, the satellite A recognizes that the MsgA comes from an edge signaling beamfoot, and sends a notification to the satellite B that shares the edge signaling beamfoot with the satellite A at the next interaction time instant.

The satellite B receives the notification sent by satellite A and receives the MsgA sent from the edge user A.

The satellite B performs service contention calculation based on information such as user density, signal strength, and satellite load contained in the notification sent by the satellite A, and obtains a contention result.

The satellite B may notify the satellite A of the obtained competition result at the next interaction time instant.

Assuming that the competition result is that the satellite A is determined to serve the edge user A, the satellite A sends the MsgB to the edge user A, and then the satellite A and the edge user A establish a connection.

After the edge user A accesses the satellite A, beam-hopping service can be performed for the traffic beam.

The satellite A and the satellite B exchange information including the edge user density in each scheduling cycle. Edge user density refers to the number of users per unit area on the edge signaling beamfoot.

When performing service transmission, it is necessary to transmit according to the beam-hopping pattern.

Before each scheduling period starts, it is necessary to determine whether the pre-determined beam-hopping pattern for the next scheduling period needs to be adjusted.

Since there are edge users in the overlapping area between the service ranges of satellite A and satellite B, assuming that the edge user density of satellite A is determined to be lower, it is up to satellite A to determine whether to adjust the beam-hopping pattern.

FIG. 7 is a schematic diagram of adjusting a beam-hopping pattern in an embodiment of the present disclosure. In FIG. 7, a beam-hopping pattern include a set of grids in two dimensions {time slot in x axis, traffic beamfoot in y axis}, and each gird is represented by {a time slot index, and a traffic beamfoot index}.

In each time slot, the first traffic beamfoot set refers to a set of traffic beamfoots being illuminated in the beam-hopping pattern of the satellite A (see left of FIG. 7), and the second traffic beamfoot set is a set of traffic beamfoots being illuminated in the beam-hopping pattern of the satellite B (see right of FIG. 7).

As shown in FIG. 7, in a current time slot, there is a conflicting edge traffic beamfoot X1 in the first traffic beamfoot set, which is conflicted by an edge traffic beamfoot X2 in the second traffic beamfoot set. As described in the above step 303, the center of the conflicting edge traffic beamfoot X1 is close to the center of the edge traffic beamfoot X2. In specific, the ground distance between two centers is lower than the preset center distance.

Further, in the third traffic beamfoot set, a candidate traffic beamfoot Y is determined to adjust the conflicting edge traffic beamfoot XL. In other words, the traffic beamfoot Y has a distance away from the conflicting edge traffic beamfoot X1 not exceeding the preset distance threshold and also being the minimum distance among all the candidate traffic beamfoots in the third traffic beamfoot set.

In embodiments of the present disclosure, the preset distance threshold used for selecting the candidate traffic beamfoot is larger than the preset center distance described above for determining the conflicting traffic beamfoot. As shown in FIG. 7, the center distance between the conflicting edge traffic beamfoot X1 and the candidate traffic beamfoot Y is larger than the center distance between the conflicting edge traffic beamfoot X1 and the edge traffic beamfoot X2. As a result, after replacing the conflicting traffic beamfoot X1 with the candidate traffic beamfoot Y, the conflicting is eliminated.

If satellite A determines that no edge traffic beamfoots are illuminated in the first traffic beamfoot set and the second traffic beamfoot set at the same time (e.g., only edge traffic beamfoots in the first traffic beamfoot set are illuminated, only edge traffic beamfoots in the second traffic beamfoot set are illuminated, or no edge traffic beamfoots are illuminated in the first traffic beamfoot set and the second traffic beamfoot set); or, after the conflicting traffic beamfoot has been adjusted, satellite A determines whether all time slots of the next scheduling period have been traversed, if so, outputs the second beam-hopping pattern; otherwise, traverses the next time slot, and performs the adjustment if needed for the next time slot.

If the first beam-hopping pattern is adjusted for the next scheduling period, the output is the second beam-hopping pattern, i.e., the adjusted beam-hopping pattern; if the first beam-hopping pattern is not adjusted, the output is the single-satellite beam-hopping pattern.

When the next scheduling period starts, the beam-hopping service for the traffic beam is performed according to the output beam-hopping pattern.

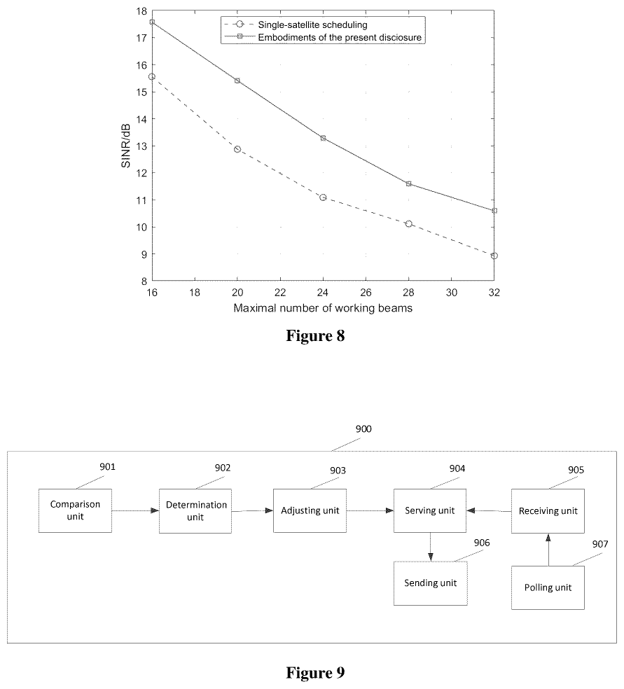

FIG. 8 is a graph showing performance results in an embodiment of the present disclosure. In FIG. 8, there are two curves generated respectively according to a single-satellite scheduling (i.e., no inter-satellite coordination) and embodiments of the present disclosure (i.e., a kind of inter-satellite joint scheduling). Each curve shows the relationship between the downlink average SINR and the maximal number of working beams.

The simulation is performed based on the following system data and application scenarios:

Considering the low-orbit satellite beam-hopping communication system, the orbit height is 508 km, and the satellite is equipped with a noise-free phased array multi-beam antenna, which can support a maximal number of N_b=16-32 working beams simultaneously. The total antenna power is P_T=300 W, each beam is a single carrier with a bandwidth of B_W=40 MHz, and the center frequency is f_0=3 GHz. The number of users in the coverage area of the satellite is N_u=400, and their service requests follow a Poisson distribution. Considering that the beam provides a gain of at the beam center G_b=36.2 dBi, and the beam directly illuminates a single user during beam-hopping communication.

Considering that all user antennas point to the satellite, the receiving gain is G_u=−2 dBi, the antenna noise temperature T_n=150 K, and the receiver noise coefficient F_n=7 dB. The satellite provides users with periodically scheduled beam-hopping services according to the beam scheduling period T_s=40 ms. The minimum scheduling granularity is a slot of duration T_0=0.5 ms, with T_s=N_s·T_0, N_s=80. Considering a clear and cloudless sky, a calm atmosphere, no ionospheric scintillation, and a temperature of T_a=300 K.

From the performance results shown in FIG. 8, it can be seen that in the embodiments of the present disclosure, under the premise of the same maximal number of working beams, the average downlink SINR of inter-satellite joint scheduling, i.e., according to embodiments of the present disclosure, is much greater than the average SINR of single-satellite scheduling.

In embodiments of the present disclosure, a dual access request mechanism for edge users and an adjustment of beam-hopping patterns based on inter-satellite links are disclosed. This implementation scheme according to embodiments of the present disclosure can adapt to communications in highly dynamic scenarios and is sensitive to resource changes caused by high-speed satellite movement. It also improves communication capacity, reduces beam interference, and increases average user throughput. It is also suitable for large-scale low-orbit satellite constellation systems and has good robustness.

All the above optional technical solutions can be arbitrarily combined to form optional embodiments of the present disclosure, which will not be described one by one here.

Based on the above method embodiments, an apparatus for inter-satellite beam-hopping scheduling is also provided in an embodiment of the present disclosure. Applied to a first satellite, the service ranges of the first satellite and the second satellite have an overlapping area. See FIG. 9, which is a schematic diagram of the structure of an apparatus for inter-satellite beam-hopping scheduling according to an embodiment of the present disclosure. The apparatus 900 includes:

The comparison unit 901 is configured to compare, in response to edge users existing in an overlapping area, a first edge user density of the first satellite and a second edge user density of the second satellite, before a next scheduling cycle starts, service ranges of the first satellite and a second satellite having the overlapping area, edge users being users in an edge signaling beamfoot, the edge signaling beamfoot being a signaling beamfoot in the overlapping area, and an edge user density being the number of users per unit area on the edge signaling beamfoot.

The determination unit 902 is configured to traverse, in response to the first edge user density being lower than the second edge user density, time slots in the next scheduling cycle, to determine whether to adjust a first beam-hopping pattern pre-determined for the first satellite.

The adjusting unit 903 is configured to adjust, in response to determining to adjust the first beam-hopping pattern, the first beam-hopping pattern to obtain a second beam-hopping pattern.

The serving unit 904 is configured to perform, in the next scheduling cycle, beam-hopping service for a traffic beam according to the second beam-hopping pattern.

In another embodiment, the serving unit 904 is configured to perform, in response to the second edge user density being lower than the first edge user density, the beam-hopping service for the traffic beam according to the first beam-hopping pattern in the next scheduling cycle.

In another embodiment, the serving unit 904 is configured to perform, in response to determining not to adjust the first beam-hopping pattern, the beam-hopping service for the traffic beam according to the first beam-hopping pattern in the next scheduling cycle.

In another embodiment, the determination unit 902 is configured to for each time slot, determine whether there is at least one edge traffic beamfoot available in both a first traffic beamfoot set and a second traffic beamfoot set, wherein the edge traffic beamfoot is a traffic beamfoot in the overlapping area, the first traffic beamfoot set is a set of traffic beamfoots being illuminated in the first beam-hopping pattern, and the second traffic beamfoot set is a set of traffic beamfoots being illuminated in a pre-determined beam-hopping pattern of the second satellite; determine, in response to the at least one edge traffic beamfoot being available in both the first traffic beamfoot set and the second traffic beamfoot set, that the first beam-hopping pattern is to be adjusted.

In another embodiment, the determination unit 902 is further configured to determine a third traffic beamfoot set, the third traffic beamfoot set comprising at least one candidate traffic beamfoot;

and the adjusting unit 903 is configured to for each time slot, determine a conflicting traffic beamfoot in the first beam-hopping pattern within the respective time slot, the conflicting traffic beamfoot being one of the at least one edge traffic beamfoot; determine, in the third traffic beamfoot set, a candidate traffic beamfoot with a distance away from the conflicting traffic beamfoot not exceeding a preset distance threshold; and replace the conflicting traffic beamfoot in the first beam-hopping pattern with the candidate traffic beamfoot, to obtain the second beam-hopping pattern.

In another embodiment, the determination unit 902 is further configured to cancel the candidate traffic beamfoot in the third traffic beamfoot set; determine the third traffic beamfoot set based on the first traffic beamfoot set, a fourth traffic beamfoot set, and a fifth traffic beamfoot set, wherein the fourth traffic beamfoot set is a set of traffic beamfoots of the first satellite corresponding to the edge users; the fifth traffic beamfoot set corresponds to a time slot within which no edge traffic beamfoots of the first satellite are illuminated and at least one edge traffic beamfoot of the second satellite is illuminated.

In another embodiment, the apparatus 900 further includes: a receiving unit 905, and a sending unit 906, wherein
The receiving unit 905 is configured to receive a notification sent by the second satellite and an access request sent by the edge user;
The serving unit 904 is configured to determine, in response to receiving an access request sent by a user terminal of an edge user and receiving a notification sent by the second satellite, a serving satellite for the edge user, wherein the notification is sent by the second satellite after receiving the access request sent by the user terminal;
The sending unit 906 is configured to send, in response to determining the serving satellite being the first satellite, an access response to the user terminal.

In another embodiment, the serving unit 904 is configured to determine, in response to receiving an access request sent by a user terminal of an edge user and not receiving a notification sent by the second satellite, whether the access request is received via an edge signaling beam;

The sending unit 906 is configured to send, in response to determining the access request is received via the edge signaling beam, a notification to the second satellite; and send, in response to the second satellite determining a serving satellite for the edge user being the first satellite, an access response to the user terminal.

In another embodiment, the apparatus 900 further includes: a polling unit 907.

The polling unit 907 is configured to poll, through a signaling beam, each user in a coverage area of the first satellite according to a pre-determined signaling beamfoot;

The receiving unit 905 is configured to obtain information reported by a user terminal of the each user, to determine whether the each user is accessed to the first satellite.

The units in the above-mentioned embodiments may be integrated into one body or deployed separately; they may be combined into one unit or further divided into multiple sub-units.

In another embodiment, an electronic device is also provided, including a memory, a processor, and a computer program stored in the memory and executable on the processor. When the processor executes the program, a method for inter-satellite beam-hopping scheduling can be implemented.

In another embodiment, a computer-readable storage medium is provided, on which computer instructions are stored. When the instructions are executed by a processor, a method for inter-satellite beam-hopping scheduling can be implemented.

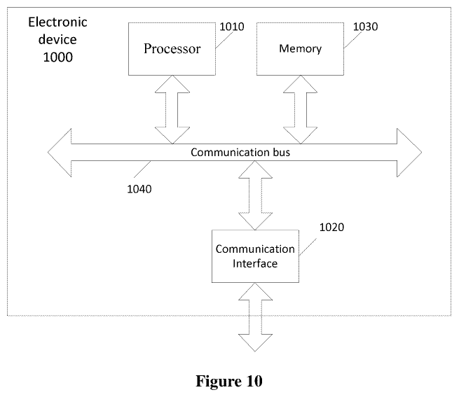

FIG. 10 is a schematic diagram of the physical structure of an electronic device 1000 provided by an embodiment of the present invention. As shown in FIG. 10, the electronic device 1000 may include: a processor 1010, a communication interface 1020, a memory 1030 and a communication bus 1040, wherein the processor 1010, the communication interface 1020, and the memory 1030 communicate with each other through the communication bus 1040. The processor 1010 may call the logic instructions in the memory 1030 to execute the method for inter-satellite beam-hopping scheduling as described above.

In addition, the logic instructions in the above-mentioned memory 1030 can be implemented in the form of a software functional unit and can be stored in a computer-readable storage medium when it is sold or used as an independent product. Based on such an understanding, the technical solution of the present invention is essentially or the part that contributes to the prior art or the part of the technical solution can be embodied in the form of a software product, and the computer software product is stored in a storage medium, including a number of instructions to enable a computer device (which can be a personal computer, a server, or a network device, etc.) to perform all or part of the steps of the methods of various embodiments of the present invention. The aforementioned storage medium includes: U disk, mobile hard disk, read-only memory (ROM, Read-Only Memory), random access memory (RAM, Random Access Memory), disk or optical disk and other media that can store program codes.

The device embodiments described above are merely illustrative, wherein the units described as separate components may or may not be physically separated, and the components displayed as units may or may not be physical units, that is, they may be located in one place, or they may be distributed on multiple network units. Some or all of the modules may be selected according to actual needs to achieve the purpose of the scheme of this embodiment. Those of ordinary skill in the art may understand and implement it without creative work.

Through the description of the above implementation methods, those skilled in the art can clearly understand that each implementation method can be implemented by means of software plus a necessary general hardware platform, and of course, it can also be implemented by hardware. Based on this understanding, the above technical solution is essentially or the part that contributes to the prior art can be embodied in the form of a software product, and the computer software product can be stored in a computer-readable storage medium, such as ROM/RAM, a disk, an optical disk, etc., including a number of instructions for a computer device (which can be a personal computer, a server, or a network device, etc.) to execute the methods described in each embodiment or some parts of the embodiment.

The flow chart and block diagram in the accompanying drawings of the present disclosure show the possible architecture, function and operation of the system, method and computer program product according to the various embodiments disclosed in the present disclosure. In this regard, each box in the flow chart or block diagram can represent a module, a program segment or a part of a code, and the above-mentioned module, program segment or a part of a code contains one or more executable instructions for realizing the specified logical function. It should also be noted that in some implementations as replacements, the functions marked in the box can also occur in the order of the standards in different figures. For example, the boxes represented by two connections can actually be executed substantially in parallel, and they can sometimes be executed in the opposite order, depending on the functions involved. It should also be noted that each box in the block diagram or flow chart, and the combination of the boxes in the block diagram or flow chart can be implemented with a dedicated hardware-based system that performs the specified function or operation, or can be implemented with a combination of dedicated hardware and computer instructions.

Those skilled in the art will appreciate that the features described in the various embodiments and/or claims disclosed in this disclosure may be combined and/or combined in a variety of ways, even if such combinations and/or combinations are not explicitly described in this disclosure. In particular, without departing from the spirit and teachings of this disclosure, the features described in the various embodiments and/or claims of this disclosure may be combined and/or combined in a variety of ways, and all of these combinations and/or combinations fall within the scope disclosed in this disclosure.

Specific embodiments are used herein to illustrate the principles and implementation methods of the present invention. The description of the above embodiments is only used to help understand the method of the present invention and its core ideas, and is not used to limit the present disclosure. For those skilled in the art, changes can be made in the specific implementation methods and application scopes according to the ideas, spirits and principles of the present invention, and any modifications, equivalent substitutions, improvements, etc. made therein should be included in the scope of protection of this disclosure.

What is claimed is:

1. A method for inter-satellite beam-hopping scheduling, applied to a first satellite, wherein service ranges of the first satellite and a second satellite have an overlapping area, and the method comprises:
comparing, in response to edge users existing in the overlapping area, a first edge user density of the first satellite and a second edge user density of the second satellite, before a next scheduling cycle starts, edge users being users in an edge signaling beamfoot, the edge signaling beamfoot being a signaling beamfoot in the overlapping area, and an edge user density being the number of users per unit area on the edge signaling beamfoot;
traversing, in response to the first edge user density being lower than the second edge user density, time slots in the next scheduling cycle, to determine whether to adjust a first beam-hopping pattern pre-determined for the first satellite;
adjusting, in response to determining to adjust the first beam-hopping pattern, the first beam-hopping pattern to obtain a second beam-hopping pattern; and
performing, in the next scheduling cycle, beam-hopping service for a traffic beam according to the second beam-hopping pattern.

2. The method according to claim 1, further comprises:
performing, in response to the second edge user density being lower than the first edge user density, the beam-hopping service for the traffic beam according to the first beam-hopping pattern in the next scheduling cycle.

3. The method according to claim 1, further comprises:
performing, in response to determining not to adjust the first beam-hopping pattern, the beam-hopping service for the traffic beam according to the first beam-hopping pattern in the next scheduling cycle.

4. The method according to claim 1, wherein the traversing comprises:
for each time slot, performing the following:
determining whether there is at least one edge traffic beamfoot available in both a first traffic beamfoot set and a second traffic beamfoot set, wherein
the edge traffic beamfoot is a traffic beamfoot in the overlapping area,
the first traffic beamfoot set is a set of traffic beamfoots being illuminated in the first beam-hopping pattern, and
the second traffic beamfoot set is a set of traffic beamfoots being illuminated in a pre-determined beam-hopping pattern of the second satellite;
determining, in response to the at least one edge traffic beamfoot being available in both the first traffic beamfoot set and the second traffic beamfoot set, that the first beam-hopping pattern is to be adjusted.

5. The method according to claim 4, further comprises:
determining a third traffic beamfoot set, the third traffic beamfoot set comprising at least one candidate traffic beamfoot;
wherein the adjusting comprises:
for each time slot, performing the following:
determining a conflicting traffic beamfoot in the first beam-hopping pattern within the respective time slot, the conflicting traffic beamfoot being one of the at least one edge traffic beamfoot;
determining, in the third traffic beamfoot set, a candidate traffic beamfoot with a distance away from the conflicting traffic beamfoot not exceeding a preset distance threshold; and
replacing the conflicting traffic beamfoot in the first beam-hopping pattern with the candidate traffic beamfoot, to obtain the second beam-hopping pattern.

6. The method according to claim 5, further comprises:
cancelling the candidate traffic beamfoot in the third traffic beamfoot set;
wherein the determining the third traffic beamfoot set comprises:
determining the third traffic beamfoot set based on the first traffic beamfoot set, a fourth traffic beamfoot set, and a fifth traffic beamfoot set, wherein
the fourth traffic beamfoot set is a set of traffic beamfoots of the first satellite corresponding to the edge users;
the fifth traffic beamfoot set corresponds to a time slot within which no edge traffic beamfoots of the first satellite are illuminated and at least one edge traffic beamfoot of the second satellite is illuminated.

7. The method according to claim 1, further comprises:
determining, in response to receiving an access request sent by a user terminal of an edge user and receiving a notification sent by the second satellite, a serving satellite for the edge user, wherein the notification is sent by the second satellite after receiving the access request sent by the user terminal;
sending, in response to determining the serving satellite being the first satellite, an access response to the user terminal.

8. The method according to claim 1, further comprising:
determining, in response to receiving an access request sent by a user terminal of an edge user and not receiving a notification sent by the second satellite, whether the access request is received via an edge signaling beam;
sending, in response to determining the access request is received via the edge signaling beam, a notification to the second satellite;
sending, in response to the second satellite determining a serving satellite for the edge user being the first satellite, an access response to the user terminal.

9. The method according to claim 1, further comprises:
polling, through a signaling beam, each user in a coverage area of the first satellite according to a pre-determined signaling beamfoot;
obtaining information reported by a user terminal of the each user, to determine whether the each user is accessed to the first satellite.

10. An electronic device, comprising a memory, a processor, and a computer program stored in the memory that, when executed by the processor, causes the processor to:
compare, in response to edge users existing in an overlapping area, a first edge user density of the first satellite and a second edge user density of the second satellite, before a next scheduling cycle starts, service ranges of the first satellite and a second satellite having the overlapping area, edge users being users in an edge signaling beamfoot, the edge signaling beamfoot being a signaling beamfoot in the overlapping area, and an edge user density being the number of users per unit area on the edge signaling beamfoot;
traverse, in response to the first edge user density being lower than the second edge user density, time slots in the next scheduling cycle, to determine whether to adjust a first beam-hopping pattern pre-determined for the first satellite;
adjust, in response to determining to adjust the first beam-hopping pattern, the first beam-hopping pattern to obtain a second beam-hopping pattern; and
perform, in the next scheduling cycle, beam-hopping service for a traffic beam according to the second beam-hopping pattern.

11. A non-transitory computer readable medium storing a computer program causing a computer to execute a process, the process comprising:
comparing, in response to edge users existing in an overlapping area, a first edge user density of the first satellite and a second edge user density of the second satellite, before a next scheduling cycle starts, service ranges of the first satellite and a second satellite having the overlapping area, edge users being users in an edge signaling beamfoot, the edge signaling beamfoot being a signaling beamfoot in the overlapping area, and an edge user density being the number of users per unit area on the edge signaling beamfoot;
traversing, in response to the first edge user density being lower than the second edge user density, time slots in the next scheduling cycle, to determine whether to adjust a first beam-hopping pattern pre-determined for the first satellite;
adjusting, in response to determining to adjust the first beam-hopping pattern, the first beam-hopping pattern to obtain a second beam-hopping pattern; and
performing, in the next scheduling cycle, beam-hopping service for a traffic beam according to the second beam-hopping pattern.
